(19) United States
(12) Patent Application Publication
(10) Pub. No.: US 2026/0311625 A1
(43) Pub. Date: Oct. 8, 2026

(54) MULTIFOCAL NEAR-EYE DISPLAY SYSTEM AND OPERATING METHOD THEREOF

(71) Applicant: Electronics and Telecommunications Research Institute, Daejeon (KR)

(72) Inventors: Chunwon BYUN, Daejeon (KR); Jae-Hyeung PARK, Yongin-si (KR); Woongseob HAN, Cheonan-si (KR); Jiyun HAN, Suncheon-si (KR); Wooseup YOUM, Daejeon (KR); Kukjoo KIM, Daejeon (KR); Yongduck KIM, Daejeon (KR)

(73) Assignee: Electronics and Telecommunications Research Institute, Daejeon (KR)

(21) Appl. No.: 19/638,699

(22) Filed: Apr. 3, 2026

(30) Foreign Application Priority Data
Apr. 8, 2025 (KR) 10-2025-0045438

(51) Int. Cl. G09G 3/20

(52) U.S. Cl. CPC G09G 3/2092; G09G 2320/0257

(57) ABSTRACT

A multifocal near-eye display system is provided. The system has a display panel including a plurality of lines, a focus conversion device configured to adjust a focal length in response to a display synchronization signal, a driving circuit configured to generate a display driving signal for sequentially driving the plurality of lines and the display synchronization signal for controlling operation of the focus conversion device according to image frames, and a controller configured to control operation of the driving circuit, calculate effective focal lengths corresponding to respective ones of the plurality of lines, and determine image depths to be displayed on respective ones of the plurality of lines based on the calculated effective focal lengths.

### CROSS-REFERENCE TO RELATED APPLICATIONS

This application claims priority under 35 U.S.C. § 119 to Korean Patent Application No. 10-2025-0045438 filed on Apr. 8, 2025, in the Korean Intellectual Property Office, the disclosure of which is incorporated by reference herein in its entirety.

### BACKGROUND

The present disclosure relates to a display system, and more particularly, to a multifocal near-eye display system and an operating method of the multifocal near-eye display system.

A multifocal near-eye display system includes a scheme of displaying images on designated multifocal planes by using passive elements and a scheme of displaying images on arbitrary multifocal planes by applying active elements. In the case where images are displayed on arbitrary multifocal planes by applying active elements, a device capable of changing a focal length (for example, a varifocal lens or a curvature-deformable mirror capable of adjusting a surface curvature) may be synchronized with a display panel to display images corresponding to multiple image depths. When active elements are applied to display images on multifocal planes, an active-matrix-based display panel may be used so that one image depth is represented in one display frame.

Meanwhile, when a multifocal near-eye display system operates, a plurality of lines within a single frame are sequentially updated, and thus different focal lengths may be applied to respective lines of the display panel.

### SUMMARY

An object of the present disclosure is to provide a multifocal near-eye display system and operating method thereof capable of displaying an image at an accurate depth in consideration of a focal length.

According to an embodiment of the present disclosure, a multifocal near-eye display system includes a display panel including a plurality of lines, a focus conversion device configured to adjust a focal length in response to a display synchronization signal, a driving circuit configured to generate a display driving signal for sequentially driving the plurality of lines and the display synchronization signal for controlling operation of the focus conversion device according to an image frame, and a controller configured to control operation of the driving circuit, calculate effective focal lengths corresponding to respective ones of the plurality of lines, and determine image depths to be displayed on respective ones of the plurality of lines based on the calculated effective focal lengths.

According to an embodiment of the present disclosure, a controller for a multifocal near-eye display system includes a display control circuit configured to control an operation of a driving circuit, an effective focal length calculator configured to calculate effective focal lengths corresponding to respective ones of a plurality of lines of a display panel, and an image depth assignment unit configured to determine image depths to be displayed on respective ones of the plurality of lines based on the calculated effective focal lengths.

According to an embodiment of the present disclosure, a method of operating a multifocal near-eye display system includes calculating effective focal lengths corresponding to respective ones of a plurality of lines of a display panel, determining image depths to be displayed on respective ones of the plurality of lines based on the calculated effective focal lengths, generating a control signal for driving a focus conversion device with a delay of a half-frame relative to a driving timing of the display panel, performing pre-compensation on image data corresponding to the plurality of lines.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating a multifocal near-eye display system according to an embodiment of the present disclosure.

FIGS. 2A and 2B are diagrams illustrating a method of driving a display panel.

FIGS. 3A and 3B are diagrams illustrating an example of an operation of a multifocal near-eye display system.

FIGS. 4A and 4B are diagrams illustrating an image depth separation phenomenon occurring in a multifocal near-eye display system.

FIGS. 5A and 5B are diagrams illustrating an image depth diffusion phenomenon occurring in a multifocal near-eye display system.

FIGS. 6A and 6B are diagrams illustrating an example of assigning image depths to lines according to an embodiment of the present disclosure.

FIGS. 7A and 7B are diagrams illustrating an example of assigning image depths to lines according to an embodiment of the present disclosure.

FIGS. 8A and 8B are diagrams illustrating lines displayed for each image depth according to an embodiment of the present disclosure.

FIGS. 9A and 9B are diagrams illustrating line-by-line defocus blur according to an embodiment of the present disclosure.

FIGS. 10A to 10D are diagrams illustrating delayed synchronized driving according to an embodiment of the present disclosure.

FIG. 11 is a block diagram illustrating a controller according to an embodiment of the present disclosure.

FIG. 12 is a block diagram illustrating a pre-compensator according to an embodiment of the present disclosure.

FIG. 13 is a diagram illustrating an example of a computing system constituting a controller according to an embodiment of the present disclosure.

FIG. 14 is a flowchart illustrating an operating method of a multifocal near-eye display system according to an embodiment of the present disclosure.

### DETAILED DESCRIPTION

Hereinafter, embodiments of the present disclosure will be described clearly and in detail so that those skilled in the art to which the present disclosure pertains can easily carry out the disclosure.

Components described with reference to the terms unit, module, block, or suffixes such as -or and -er, as well as functional blocks shown in the drawings, may be implemented in the form of software, hardware, or a combination thereof. For example, the software may include machine code, firmware, embedded code, or application software. The hardware may include electrical circuits, electronic circuits, processors, computers, integrated circuits, integrated circuit cores, pressure sensors, inertial sensors, microelectromechanical systems (MEMS), passive elements, or combinations thereof.

In the present document, each of the phrases “A or B”, “at least one of A and B”, “at least one of A or B”, “A, B, or C”, “at least one of A, B, and C”, and “at least one of A, B, or C” may include any one of the items listed together in the relevant phrase, or any possible combination of all of them.

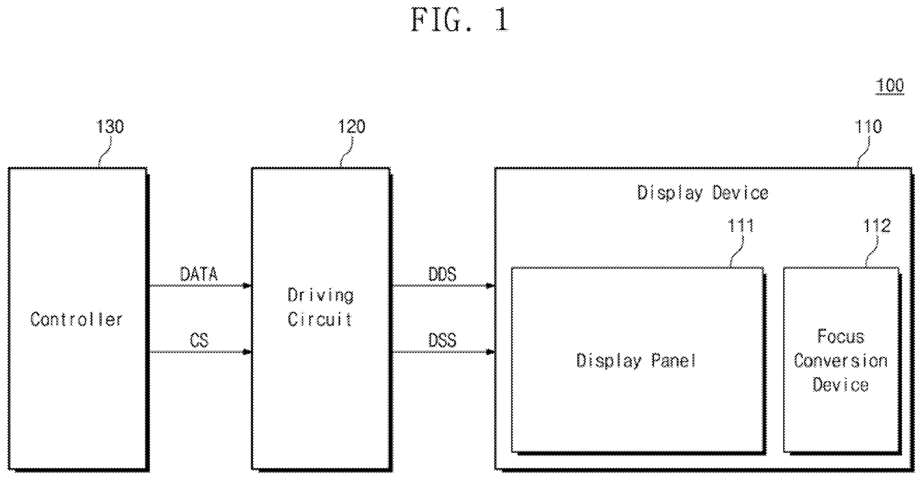

FIG. 1 is a block diagram illustrating a multifocal near-eye display system according to an embodiment of the present disclosure.

Referring to FIG. 1, the multifocal near-eye display system 100 may include a display device 110, a driving circuit 120, and a controller 130.

The multifocal near-eye display system 100 may visually provide multifocal image data to a user. In order to implement a plurality of image depths, the multifocal near-eye display system 100 may display a corresponding image at different image depths (or focal lengths). For example, the multifocal near-eye display system 100 may display a first image at a first image depth, display a second image at a second image depth, and display a third image at a third image depth.

The display device 110 may include a display panel 111 and a focus conversion device 112. A plurality of pixels may be arranged in a matrix arrangement in the display panel 111. The plurality of pixels may include a plurality of sub-pixels. Each of the plurality of pixels may display a color based on pixel data included in a display driving signal DDS. The display panel 111 may be driven in an active-matrix (AM) manner. Pixels of the display panel 111 driven in the active-matrix manner may retain its state until pixel data is updated in a subsequent frame.

The focus conversion device 112 may be interposed between a user's eye and the display panel 111. The focus conversion device 112 may adjust a focal length corresponding to an image depth. The focus conversion device 112 may adjust the focal length to a first focal length corresponding to the first image depth, a second focal length corresponding to the second image depth, or a third focal length corresponding to the third image depth. The focus conversion device 112 may be synchronized with the driving timing of display panel 111 to adjust the focal length such that an image corresponding to each image depth is displayed to the user.

The display device 110 may include a pair of display panels 111 and focus conversion devices 112 such that different images are displayed to left and right eyes, respectively. For example, the display device 110 may include a left-eye assembly (including a display panel 111 and a focus conversion device 112 for a left eye), and a right-eye assembly (including a display panel 111 and a focus conversion device 112 for a right eye). The left-eye and right-eye display panels 111 may display the different images to provide binocular disparity, while representing the images at the same image depth (i.e., at common focal distance).

The driving circuit 120 may receive image data DATA and a control signal CS from the controller 130. Based on the image data DATA and the control signal CS, the driving circuit 120 may generate a display driving signal DDS and a display synchronization signal DSS for driving the display device 110. The display driving signal DDS may be transmitted to the display panel 111. The driving circuit 120 may sequentially drive a plurality of lines of the display panel 111 through the display driving signal DDS. The driving circuit 120 may control an operation of the focus conversion device 112 through the display synchronization signal DSS. The display panel 111 may display an image corresponding to the image data DATA based on the display driving signal DDS. The display synchronization signal DSS may be transmitted to the focus conversion device 112, and the focus conversion device 112 may adjust a focal length in response to the display synchronization signal DSS. The driving circuit 120 may include a source driving circuit (or data driving circuit) configured to provide pixel data to a plurality of columns and a gate driving circuit (or scan driving circuit) configured to sequentially activate a plurality of lines.

The controller 130 may control the operation of the driving circuit 120. The controller 130 may generate image data DATA and a control signal CS associated with an image to be displayed on the display device 110. The image data DATA output by the controller 130 may include planar images corresponding to respective ones of a plurality of image depths. For example, the image data DATA may include a first planar image for the first image depth, a second planar image for the second image depth, or a third planar image for the third image depth.

The controller 130 may calculate effective focal lengths for respective ones of a plurality of lines included in the display panel 111. Based on the calculated effective focal lengths, the controller 130 may determine (or assign) an image depth for each of the plurality of lines on a per-frame basis. The controller 130 may generate the image data DATA and the control signal CS according to the image depths determined for the respective ones of the plurality of lines.

The controller 130 is configured to implement a delayed synchronization scheme. For example, the controller 130 may generate the control signal CS such that the focus conversion device 112 is driven with a half-frame delay relative to a start of an image frame scanning on the display panel 111. Based on the control signal CS, the driving circuit 120 may generate the display synchronization signal DSS having a temporal offset of half a frame, and provide the display synchronization signal DSS to the focus conversion device 112.

The controller 130 may calculate an effective point spread function (PSF) for each of the plurality of lines of the display panel 111. The controller 130 may perform pre-compensation on the image data DATA based on the effective PSF.

The multifocal near-eye display system 100 may assign an image depth to each of the plurality of lines based on the effective focal lengths. Accordingly, the multifocal near-eye display system 100 may mitigate an image depth separation phenomenon or an image depth diffusion phenomenon occurring in the display device 110 driven in an active-matrix manner. The multifocal near-eye display system 100 may minimize defocus blur in a central portion of a field of view by driving the focus conversion device 112 with a half-frame delay. In addition, the multifocal near-eye display system 100 may reduce residual defocus blur by pre-compensating the image data DATA based on the line-by-line effective PSF.

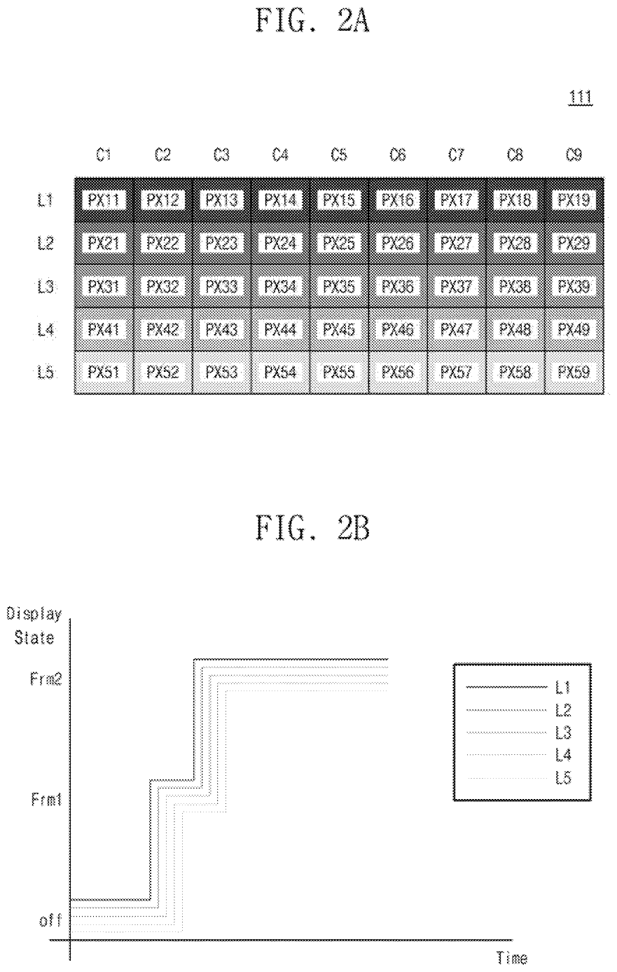

FIGS. 2A and 2B are diagrams illustrating a method of driving a display panel.

Referring to FIGS. 2A and 2B, the display panel 111 may be driven in an active-matrix manner.

FIG. 2A illustrates respective pixels displayed on the display panel 111 in a single frame. FIG. 2B illustrates display states of a plurality of lines of the display panel 111 overtime.

For convenience of description, it is assumed that the display panel 111 includes a plurality of lines L1, L2, . . . , L5 and a plurality of columns C1, C2, . . . , C9, thereby forming a plurality of pixels PX11, PX12, . . . , PX59. When an image is displayed on the display panel 111, the lines may be sequentially activated (or scanned). For example, pixels PX11 through PX19 of a first line L1 may be activated to display pixel data, and thereafter pixels PX21 through PX29 of a second line L2 may display pixel data. Subsequently, a third line L3, a fourth line L4, and a fifth line L5 may be sequentially activated. A scheme in which pixel data is sequentially updated from the lines L1 through L5 is referred to as a rolling-update scheme (or a rolling-update manner).

In one frame, each of the plurality of pixels PX11 through PX59 may be updated once. Each of the plurality of pixels PX11 through PX59 may maintain pixel data until being updated in a next frame.

The plurality of lines L1 through L5 may be initialized to an off state. In order to display a first frame Frm1, pixels PX11 through PX19 of the first line L1 may be activated. Each of the activated pixels PX11 through PX19 may display pixel data corresponding to the first frame Frm1. After the pixels PX11 through PX19 of the first line L1 are activated, pixels PX21 through PX29 of the second line L2 may be activated. The activated pixels PX21 through PX29 may display pixel data corresponding to the first frame Frm1. Thereafter, pixels of the third line L3, the fourth line L4, and the fifth line L5 may be sequentially activated. When the fifth line L5 is activated, an image corresponding to the first frame Frm1 may be displayed on the display panel 111. After the first frame Frm1 is displayed, a second frame Frm2 may be displayed.

To display the second frame Frm2, the first line L1 may be updated with pixel data corresponding to the second frame Frm2. After the first line L1 is updated, the second line L2 may be updated with pixel data corresponding to the second frame Frm2. Thereafter, pixels of the third line L3, the fourth line L4, and the fifth line L5 may be sequentially updated with pixel data corresponding to the second frame Frm2. When the fifth line L5 is updated with data corresponding to the second frame Frm2, an image corresponding to the second frame Frm2 may be displayed on the display panel 111.

That is, after display states of the lines L1 through L5 are sequentially activated with the first frame Frm1, the display states of the lines L1 through L5 are maintained until being updated. The states of the lines L1-L5 are sequentially updated with the second frame Frm2. The display panel 111 driven in an active-matrix manner may retain their state until pixel data is updated in a subsequent frame.

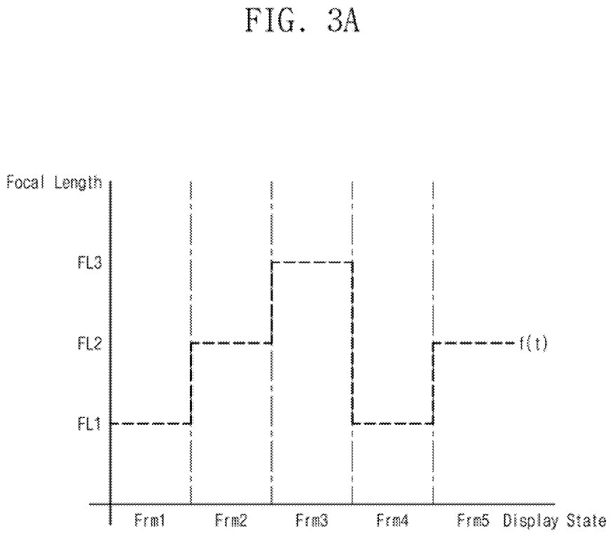

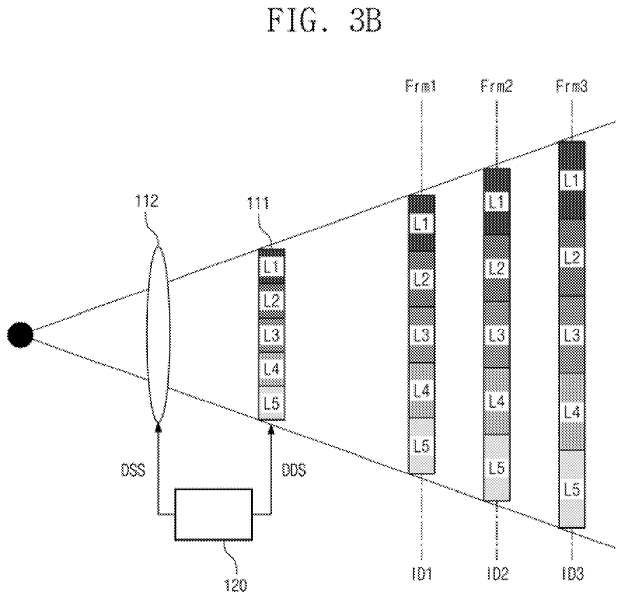

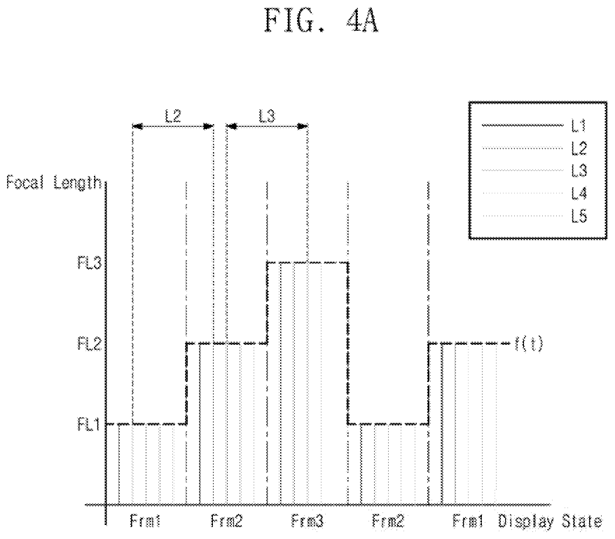

FIGS. 3A and 3B are diagrams illustrating an example of an operation of a multifocal near-eye display system.

Referring to FIGS. 3A and 3B, the multifocal near-eye display system 100 may display a multifocal image having a plurality of image depths ID1, ID2, and ID3.

FIG. 3A illustrates a focal length of a focus conversion device 112 according to a display state of the display panel 111. FIG. 3B illustrates frames Frm1, Frm2, and Frm3 corresponding to respective ones of the plurality of image depths ID1 through ID3. This is merely an example, and the multifocal near-eye display system 100 may represent more than three image depths or fewer than three image depths. To this end, a plurality of frames may correspond to respective ones of the image depths.

The focus conversion device 112 may receive a display synchronization signal DSS from the driving circuit 120. The focus conversion device 112 may include a varifocal optical system. The focus conversion device 112 may implement a plurality of image depths by adjusting a focus (or focal length) of the varifocal optical system. Based on the display synchronization signal DSS, the focus conversion device 112 may adjust a focal length f(t) of the varifocal optical system to a first focal length FL1, a second focal length FL2, and a third focal length FL3. The number of focal lengths may vary depending on the number of image depths to be represented. For example, when two image depths are to be represented, the focal length f(t) of the varifocal optical system may be adjusted between the first focal length FL1 and the second focal length FL2. Hereinafter, for convenience of description, it is assumed that three focal lengths FL1, FL2, and FL3 are used to implement the image depths ID1, ID2, and ID3.

The focus conversion device 112 may adjust the focal length f(t) of the varifocal optical system to the first focal length FL1 corresponding to the first frame Frm1. The focus conversion device 112 may adjust the focal length f(t) of the varifocal optical system to the second focal length FL2 corresponding to the second frame Frm2. The focus conversion device 112 may adjust the focal length of the varifocal optical system to the third focal length FL3 corresponding to the third frame Frm3.

Image data of the first frame Frm1 may correspond to image data for the first image depth ID1. Image data of the second frame Frm2 may correspond to image data for the second image depth ID2. And, image data of the third frame Frm3 may correspond to image data for the third image depth ID3.

While a display state of the display panel 111 corresponds to the first frame Frm1, the focal length of the focus conversion device 112 is maintained at the first focal length FL1, and an image of the first frame Frm1 may be displayed at the first image depth ID1. Thereafter, while the display state of the display panel 111 corresponds to the second frame Frm2, the focal length of the focus conversion device 112 is maintained at the second focal length FL2, and an image of the second frame Frm2 may be displayed at the second image depth ID2. While the display state of the display panel 111 corresponds to the third frame Frm3, the focal length of the focus conversion device 112 is maintained at the third focal length FL3, and an image of the third frame Frm3 may be displayed at the third image depth ID3.

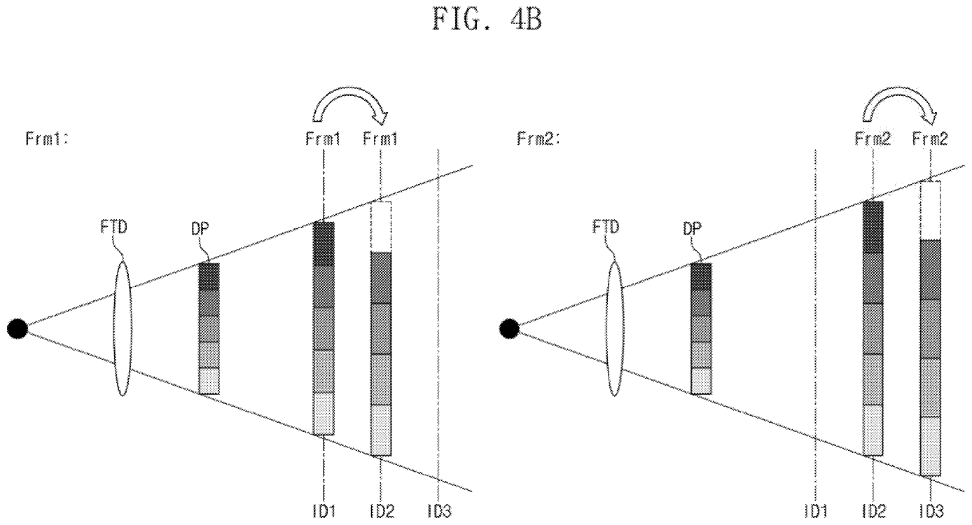

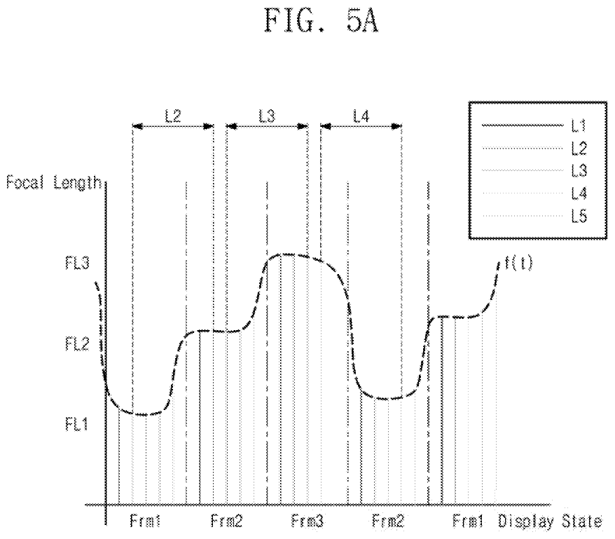

FIGS. 4A and 4B are diagrams illustrating an image depth separation phenomenon occurring in a multifocal near-eye display system.

Referring to FIGS. 4A and 4B, in the case of the display panel 111 driven in an active-matrix manner, image depth information may become ambiguous due to a change in focal length.

During a first frame Frm1, the lines L1 through L5 of the display panel 111 may sequentially display pixel data corresponding to the first frame Frm1. In this case, the focal length of the focus conversion device 112 is maintained at the first focal length FL1. After the fifth line L5 displays pixel data of the first frame Frm1, operation for a second frame Frm2 begins (or the process proceeds to the second frame Frm2).

After the second frame Frm2 begins, pixel data corresponding to the second frame Frm2 is sequentially displayed on the lines L1 through L5. Simultaneously, the focal length of the focus conversion device 112 is adjusted to the second focal length FL2. In this case, although pixel data of the first line L1 is updated to pixel data of the second frame Frm2, pixel data of the remaining lines L2 through L5 still corresponds to (or remains as) pixel data of the first frame Frm1. That is, a situation occurs in which pixel data of the first frame Frm1 is partially displayed even at the second image depth ID2.

Similarly, during the frame Frm2, pixel data corresponding to the second frame Frm2 is sequentially updated on the lines L1 through L5. Thereafter, when a third frame Frm3 begins, and the focal length of the focus conversion device 112 is adjusted to a third focal length FL3. In this case, although pixel data of the first line L1 is updated to pixel data of the third frame Frm3, pixel data of the remaining lines L2 through L5 still corresponds to (or remains as) pixel data of the second frame Frm2. Accordingly, pixel data of the second frame Frm2 is partially displayed even at the third image depth ID3.

In the display panel 111 driven in an active-matrix manner, due to a rolling update, a situation occurs in which some pixel data persist across a plurality of image depths. Accordingly, a portion of pixel data of the first frame Frm1 is represented at both the first image depth ID1 and the second image depth ID2, and a portion of pixel data of the second frame Frm2 is represented at both the second image depth ID2 and the third image depth ID3. Due to such an image depth mismatch (or separation phenomenon), image depth information perceived by a user may become ambiguous.

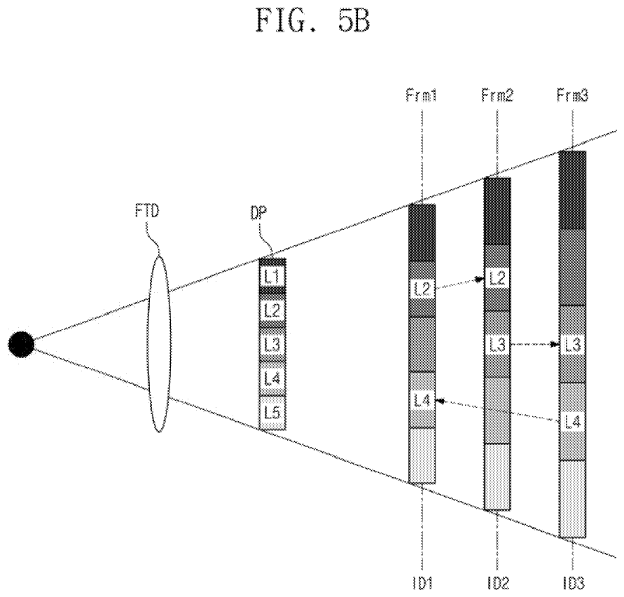

FIGS. 5A and 5B are diagrams illustrating an image depth diffusion phenomenon occurring in a multifocal near-eye display system.

Referring to FIGS. 5A and 5B, in a practical implementation, when an actual driving profile related to a focal length is taken into consideration, image depth information may become relatively more ambiguous.

FIG. 5A illustrates an example of a driving profile of a focal length of the focus conversion device 112 in a practical implementation. The focal length adjusted by the focus conversion device 112 may change relatively smoothly in a continuous manner rather than changing in a step-function form for each frame. For example, an image depth of a second line L2 corresponding to a first frame Frm1 may diffuse (or transition) from a first image depth ID1 to a second image depth ID2, and the image depth may change continuously. Similarly, an image depth of a third line L3 corresponding to a second frame Frm2 may diffuse from the second image depth ID2 to a third image depth ID3. An image depth of a fourth line L4 corresponding to a third frame Frm3 may diffuse from the third image depth ID3 to the first image depth ID1.

The image depth diffusion may occur differently for respective ones of lines L1 through L5 of the display panel 111. Due to such an image depth diffusion phenomenon, image depth information of a displayed image may become relatively more ambiguous than the image depth separation phenomenon described with reference to FIGS. 4A and 4B.

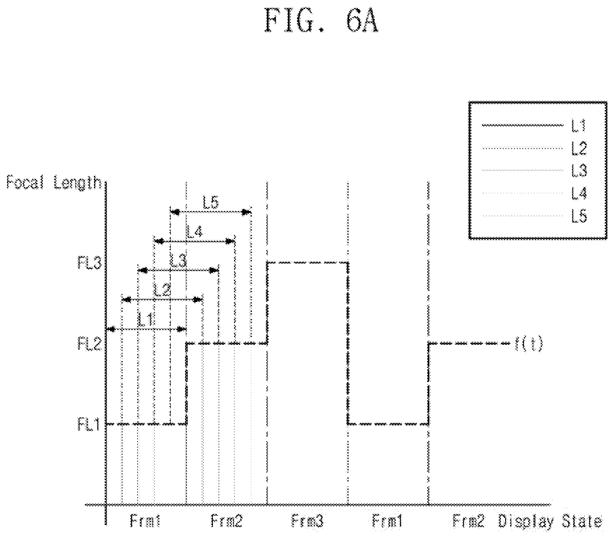

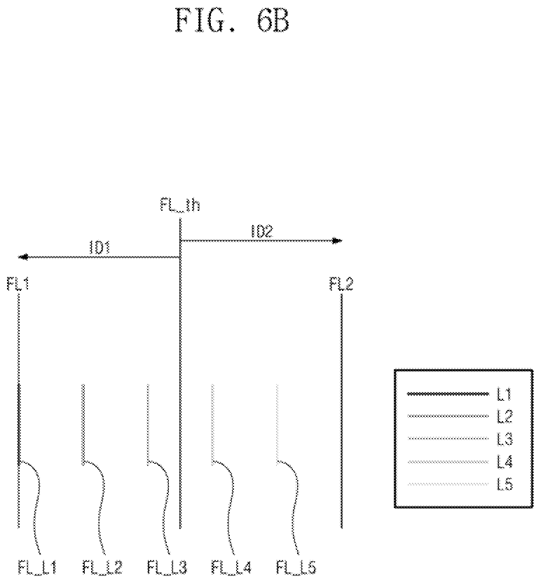

FIGS. 6A and 6B are diagrams illustrating an example of assigning image depths to lines according to an embodiment of the present disclosure.

Referring to FIGS. 6A and 6B, effective focal lengths for respective ones of a plurality of lines L1 through L5 may be calculated.

As discussed above with reference to FIGS. 2A to 5B, in the display device 110 of the multifocal near-eye display system 100, pixel data of the display panel 111 may be represented at different image depths for respective ones of the plurality of lines L1-L5. The effective focal length for each of the plurality of lines L1-L5 may be calculated based on Equation 1 below.

$${f}_{L , N} = {W}_{N}^{1 st} \times {f}_{1 st} + {W}_{N}^{2 n d} \times {f}_{2 n d} \qquad [ Equation 1 ]$$

In Equation 1, f_{L,N} denotes an effective focal length of an N-th line, f₁ₛₜ denotes a focal length of the focus conversion device 112 at a time when pixel data of the N-th line is updated, and f_{2nd} denotes a focal length of the focus conversion device 112 immediately before an update in a next frame at the N-th line.

$${W}_{N}^{1 st}$$

denotes a time weight when the focal length of the focus conversion device 112 is f₁ₛₜ at the N-th line, and

$${W}_{N}^{2 n d}$$

denotes a time weight when the focal length of the focus conversion device 112 is f_{2nd} at the N-th line.

Even when the focus conversion device 112 adjusts a focal length in ideal synchronization with frames Frm1, Frm2, and Frm3, in the case of the display device 110 driven in a rolling update manner based on the active-matrix, effective focal lengths of respective ones of a plurality of lines L1 through L5 may be different from each other. For example, calculated effective focal lengths of the first line L1, the second line L2, and the third line L3 may be relatively closer to the first focal length FL1. On the other hand, calculated effective focal lengths of the fourth line L4 and the fifth line L5 may be relatively closer to the second focal length FL2. In this case, a first image depth ID1 may be assigned to the first line L1, the second line L2, and the third line L3, and a second image depth ID2 may be assigned to the fourth line L4 and the fifth line L5.

FIG. 6B illustrates effective focal lengths FL_L1, FL_L2, . . . , FL_L5 of respective ones of a plurality of lines L1 through L5 in the first frame Frm1. Effective focal lengths of the lines L1 through L5 are denotes as FL_L1 through FL_L5, respectively. Among the plurality of lines L1 through L5, a first image depth ID1 may be assigned to the first line L1, the second line L2, and the third line L3, for which calculated effective focal lengths correspond to a first focal length FL1 based on (or relative to) a threshold focal length FL_th. Among the plurality of lines L1 through L5, a second image depth ID2 may be assigned to the fourth line L4 and the fifth line L5, for which calculated effective focal lengths correspond to a second focal length FL2 based on (or relative to) the threshold focal length FL_th.

Each of the plurality of lines L1 through L5 may display pixel data corresponding to the image depth assigned thereto. For example, in the first frame Frm1, the lines L1 through L3 may display pixel data corresponding to the first focal length FL1. In the first frame Frm1, the fourth line L4 and the fifth line L5 may display pixel data corresponding to the second focal length FL2.

Meanwhile, during the first through third frames Frm1 through Frm3, all image depths may be assigned to each of the plurality of lines L1 through L5. In other words, for the first line L1, a first image depth ID1, a second image depth ID2, and a third image depth ID3 may be assigned during the first through third frames Frm1 through Frm3 based on effective focal lengths. Likewise, for the second through fifth lines L2 through L5, the first through third image depths ID1 through ID3 may be respectively assigned during the first through third frames Frm1 through Frm3 based on calculated effective focal lengths.

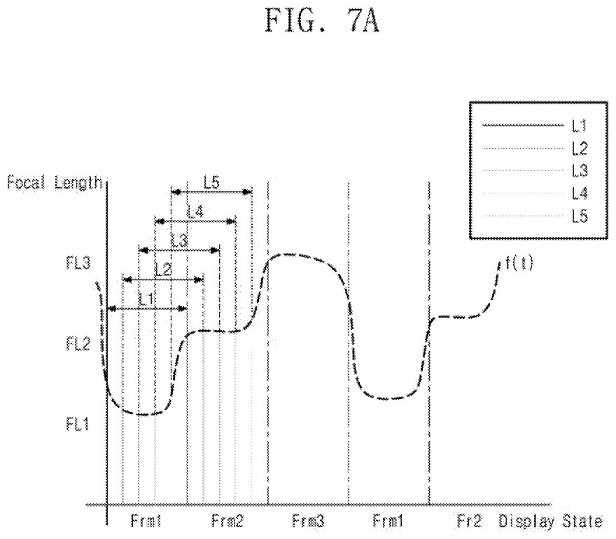

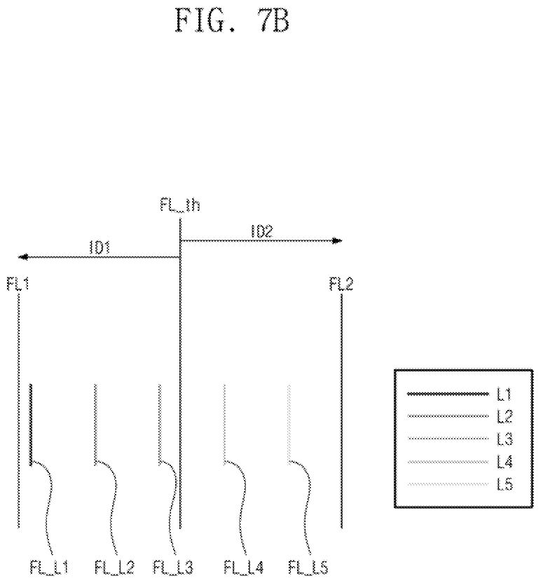

FIGS. 7A and 7B are diagrams illustrating an example of assigning image depths to lines according to an embodiment of the present disclosure.

Referring to FIGS. 7A and 7B, effective focal lengths for respective ones of a plurality of lines L1 through L5 may be calculated.

FIG. 7A illustrates a graph in which a focal length of the focus conversion device 112 changes in a continuous manner. As described with reference to FIGS. 6A and 6B, the focal length adjusted by the focus conversion device 112 may not change in a step-function form for each frame, but may change relatively smoothly in a continuous manner. In this case, effective focal lengths for respective ones of the plurality of lines L1 through L5 may be calculated based on Equation 2.

$${f}_{L , N}^{( M )} = \frac{1}{F} {\int }_{{t}_{N}^{( M )}}^{{t}_{N}^{( M + 1 )}} f ( t ) d t \qquad [ Equation 2 ]$$

In Equation 2,

$${f}_{L , N}^{( M )}$$

denotes an effective focal length of the N-th line in the M-th frame,

$${t}_{N}^{( M )}$$

denotes an update time of the N-th line in the M-th frame,

$${t}_{N}^{( M + 1 )}$$

denotes an update time of the N-th line in an (M+1)-th frame, f(t) denotes a focal length of the focus conversion device 112 as a function of time, and F denotes a duration time of one frame.

FIG. 7B illustrates effective focal lengths FL_L1, FL_L2, . . . , FL_L5 calculated for respective ones of a plurality of lines L1 through L5 in the first frame Frm1 based on Equation 2. Effective focal lengths FL_L1 of the first line L1, FL_L2 of the second line L2, and FL_L3 of the third line L3 are relatively closer to a first focal length FL1 with respect to a threshold focal length FL_th. Effective focal lengths FL_L4 of the fourth line L4 and FL_L5 of the fifth line L5 are relatively closer to a second focal length FL2 with respect to the threshold focal length FL_th. Based on the threshold focal length FL_th, a first image depth ID1 may be assigned to each of the lines L1 through L3 that are closer to the first focal length FL1, and a second image depth ID2 may be assigned to each of the lines L4 and L5 that are closer to the second focal length FL2. That is, in the first frame Frm1, the lines L1 through L3 may display pixel data corresponding to the first image depth ID1, and the lines L4 and L5 may display pixel data corresponding to the second image depth ID2.

The threshold focal length FL_th may be determined as an average value of the first focal length FL1 and the second focal length FL2. In addition to an average value of the focal lengths, the threshold focal length FL_th may be set to a value that is perceived as natural by a user.

Lines that are updated relatively later (for example, L4 and L5) may stay longer at a focal length corresponding to a subsequent image depth, and thus may be advantageous for uniformly representing a focus when outputting pixel data corresponding to the subsequent image depth (for example, ID2). That is, since effective focal lengths are determined differently for respective lines even within the same frame, displaying pixel data of different image depths within a single frame according to the calculated image depths may be more advantageous in displaying an image with a uniform focus than displaying pixel data of a single image depth entirely within one frame.

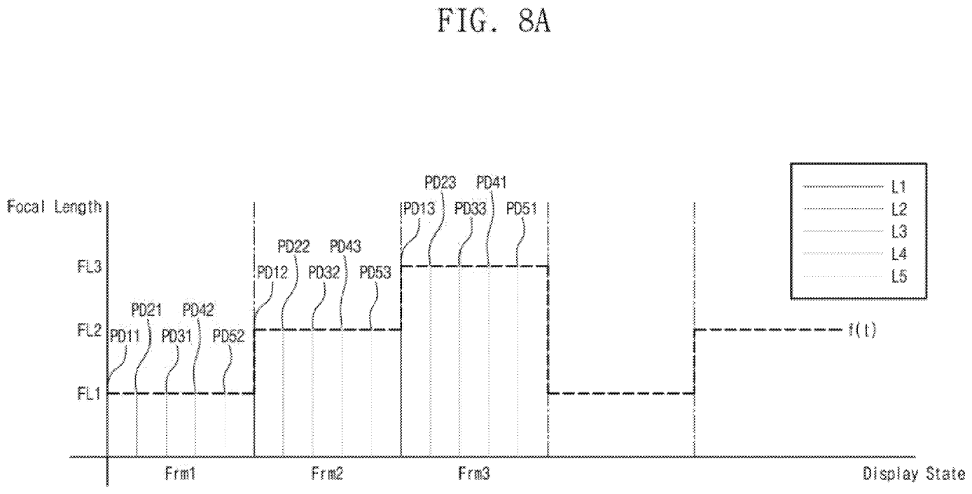

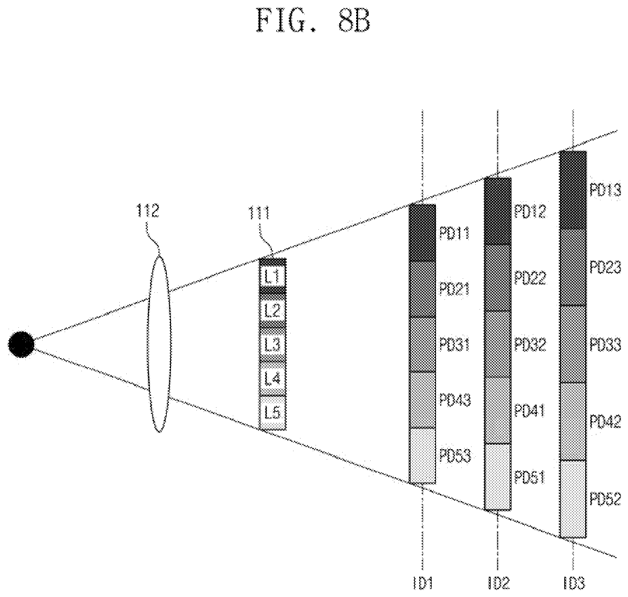

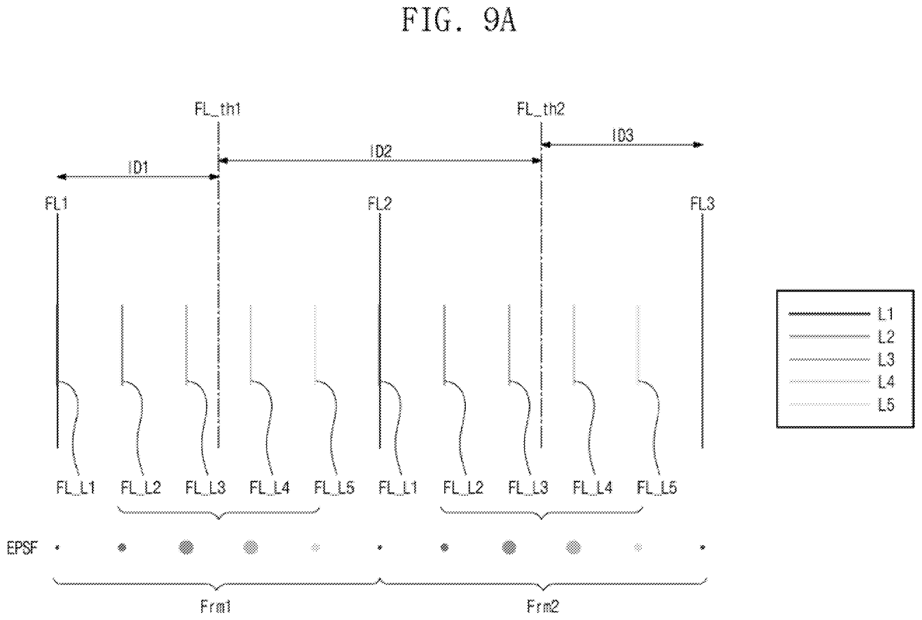

FIGS. 8A and 8B are diagrams illustrating lines displayed for each image depth according to an embodiment of the present disclosure.

Referring to FIGS. 8A and 8B, image depths ID1 through ID3 assigned to respective ones of a plurality of lines L1 through L5 for frames Frm1 through Frm3 may be identified.

In the first frame Frm1, the first line L1 may display pixel data PD11, and second line L2 may display pixel data PD21. The third line L3 may display pixel data PD31. The pixel data PD11 through PD31 correspond to the first image depth ID1.

In the first frame Frm1, the fourth line L4 may display pixel data PD42, and the fifth line L5 may display pixel data PD52. The pixel data PD42 and PD52 correspond to the second image depth ID2.

In the second frame Frm2, the lines L1 through L3 may display pixel data PD12, PD22, and PD32, respectively. The pixel data PD12, PD22, and PD32 correspond to the second image depth ID2.

In the second frame Frm2, the fourth line L4 and the fifth line L5 may display pixel data PD43 and PD53, respectively. The pixel data PD43 and PD53 correspond to the third image depth ID3.

In the third frame Frm3, the lines L1 through L3 may display a corresponding one of pixel data PD13, PD23, and PD33. The pixel data PD13, PD23, and PD33 correspond to the third image depth ID3.

In the third frame Frm3, the fourth line L4 and the fifth line L5 may display pixel data PD41 and PD51, respectively. The pixel data PD41 and PD51 correspond to the first image depth ID1.

That is, even within the same frame, pixel data corresponding to different image depths may be displayed on the plurality of lines L1 through L5 depending on effective image depths.

To represent the second image depth ID2, the fourth line L4 and the fifth line L5 in the first frame Frm1 may be used, and the lines L1 through L3 in the second frame Frm2 may be used. Through this configuration, a multi-depth image having a uniform focus may be represented.

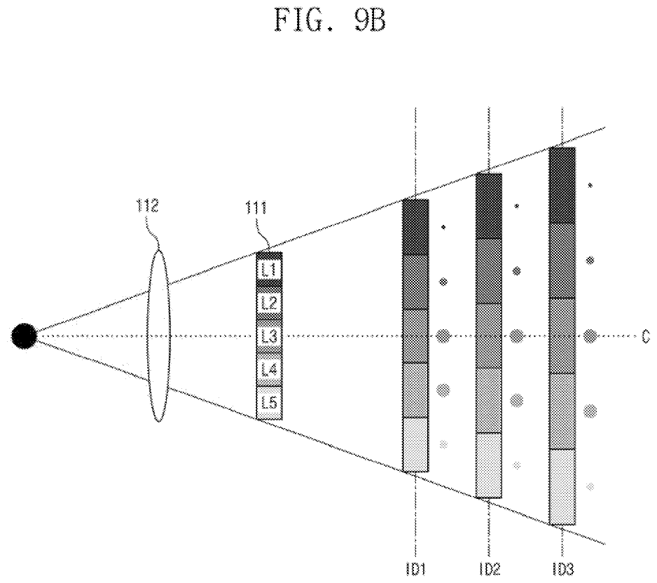

FIGS. 9A and 9B are diagrams illustrating line-by-line defocus blur according to an embodiment of the present disclosure.

Referring to FIGS. 9A and 9B, the most significant defocus blur may occur at a central region C among a plurality of lines L1 through L5.

A point spread function (PSF) is a function that describes how an optical system or an image sensor responds to a point light source. The point spread function indicates how an ideal point light source is spread in an actual image.

An effective point spread function may be determined based on differences between effective focal lengths FL_L1, FL_L2, . . . , FL_L5 of respective ones of the plurality of lines L1 through L5 and focal lengths FL1, FL2, and FL3 corresponding to image depths to be represented. For example, in the first frame Frm1, effective point spread functions (EPSFs) of the lines L1 through L3 to which the first image depth ID1 is assigned may be determined based on differences between effective focal lengths FL_L1, FL_L2, and FL_L3 and the first focal length FL1. For the first line L1, the effective focal length FL_L1 matches the first focal length FL1, and thus the effective point spread function appears as a point. For the second line L2, a difference exists between the effective focal length FL_L2 and the first focal length FL1, and thus the effective point spread function appears blurred. For the third line L3, a difference between the effective focal length FL_L3 and the first focal length FL1 is relatively larger than that of the second line L2, and thus the effective point spread function of the third line L3 appears relatively more blurred than that of the second line L2.

In the first frame Frm1, effective point spread functions of the fourth line L4 and the fifth line L5 to which the second image depth ID2 is assigned may be determined based on differences between the effective focal lengths FL_L4 and FL_L5 and the second focal length FL2. A difference between the effective focal length FL_L4 of the fourth line L4 and the second focal length FL2 is relatively larger than a difference between the effective focal length FL_L5 of the fifth line L5 and the second focal length FL2. Accordingly, the effective point spread function of the fourth line L4 appears relatively more blurred than that of the fifth line L5.

In the second frame Frm2, similarly to the first frame Frm1, the effective point spread function of the first line L1 appears as a point, becomes progressively more blurred toward the central region C, and approaches a point-like state toward edge regions.

That is, an image exhibits the greatest blur at the central region C of a user's field of view, and appears relatively sharper at peripheral regions. Accordingly, a scheme for obtaining a sharp image at the central region C of the user's field of view is required.

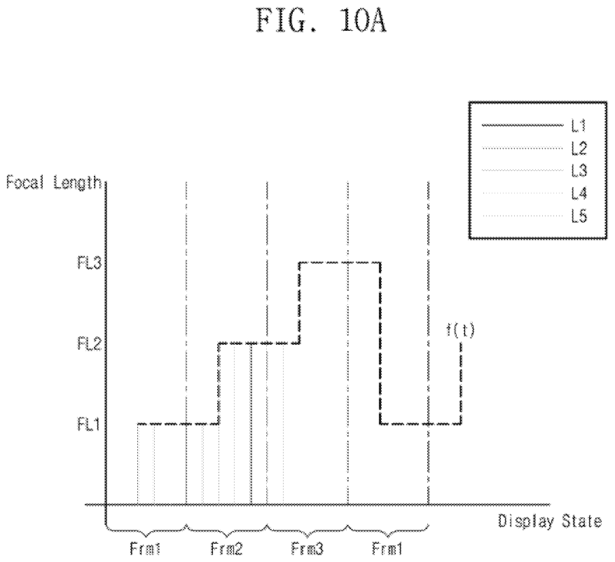

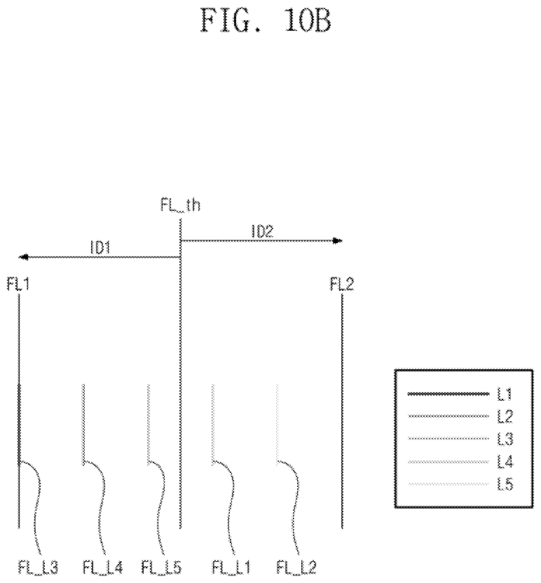

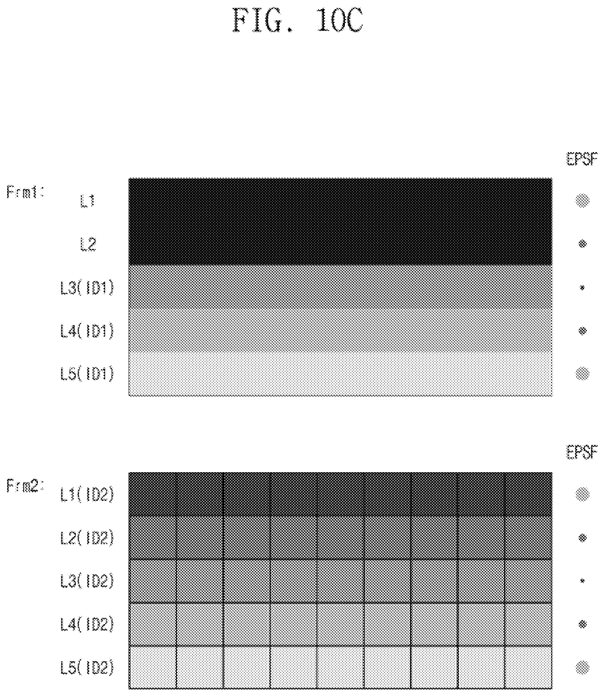

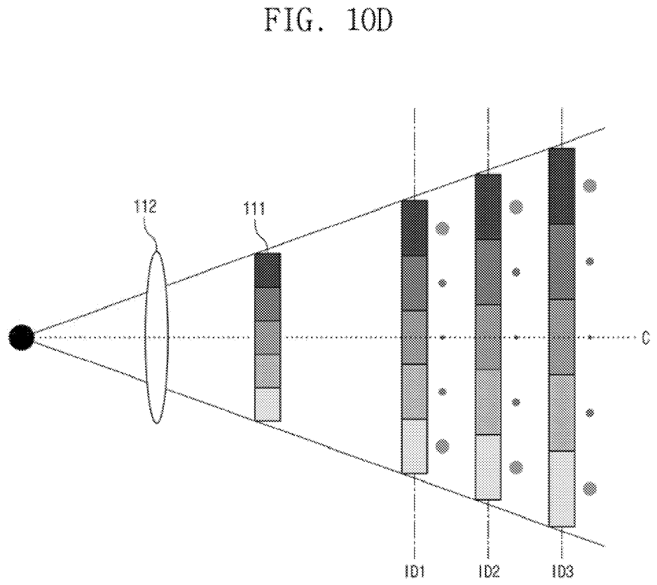

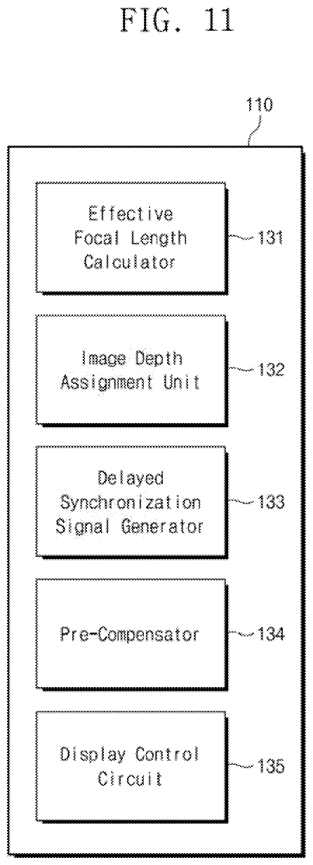

FIGS. 10A to 10D are diagrams illustrating delayed synchronized driving according to an embodiment of the present disclosure.

Referring to FIGS. 10A through 10D, a relatively sharp image may be represented at a central region C of a user's field of view.

FIG. 10A illustrates a focal length f(t) of the focus conversion device 112 to which delayed synchronization driving is applied with respect to frames Frm1, Frm2, and Frm3. FIG. 10B illustrates effective focal lengths FL_L3, FL_L4, FL_L5, FL_L1, and FL_L2 of respective ones of a plurality of lines L1 through L5 to which the delayed synchronization driving is applied. FIG. 10C illustrates lines L1 through L5 displayed in the first frame Frm1 and the second frame Frm2 and corresponding effective point spread functions (EPSFs). FIG. 10D illustrates effective point spread functions (EPSFs) at respective image depths ID1, ID2, and ID3.

According to an embodiment of the present disclosure, the focal length f(t) of the focus conversion device 112 may be delayed by a half-frame. That is, pixel data displayed on the display panel 111 may be driven with a timing advance of a half-frame relative to the focus conversion device 112. For example, the focal length f(t) of the focus conversion device 112 may be synchronized with a central line, specifically, the third line L3. The focus conversion device 112 may be configured to have the first focal length FL1 when the third line L3 displays pixel data. The focal length f(t) of the focus conversion device 112 corresponding to the first focal length FL1 may be maintained until the third line L3 of the second frame Frm2 is updated.

While the focal length f(t) of the focus conversion device 112 is maintained at the first focal length FL1, the third line L3, the fourth line L4, the fifth line L5, and the first line L1 and the second line L2 may sequentially display pixel data. When the third line L3 of the second frame Frm2 is updated, the focal length f(t) of the focus conversion device 112 may be switched from the first focal length FL1 to the second focal length FL2. Thereafter, the plurality of lines L4, L5, L1, and L2 may be sequentially updated.

In this case, in the first frame Frm1, the first image depth ID1 may be assigned to the third line L3 through the fifth line L5. In the second frame Frm2, the second image depth ID2 may be assigned to the first line L1 and the second line L2.

In the first frame Frm1, while the focal length f(t) of the focus conversion device 112 is maintained at the first focal length FL1, pixel data corresponding to the first image depth ID1 may be displayed on the lines L3 through L5. In the second frame Frm2, pixel data corresponding to the second image depth ID2 may be displayed on the first line L1 and the second line L2.

That is, in the first frame Frm1, display of the first line L1 and the second line L2 may be omitted, and pixel data may be sequentially displayed from the third line L3 through the fifth line L5. In this case, an effective point spread function (EPSF) of the third line L3 exhibits a point-like shape having the highest sharpness, and the effective point spread function becomes progressively more blurred toward the fifth line L5.

In the second frame Frm2, similar to the operation in the first frame Frm1, the third line L3 exhibits a point-like shape having the highest sharpness. As scanning proceeds to the fourth line L4 and the fifth line L5, the corresponding effective point spread functions (EPSFs) become progressively more blurred.

Through the delayed synchronization driving according to an embodiment of the present disclosure, the multifocal near-eye display system 100 may provide a multi-depth image having a sharp focus at the central region C of a user's field of view.

FIG. 11 is a block diagram illustrating a controller according to an embodiment of the present disclosure.

Referring to FIG. 11, the controller 130 may include an effective focal length calculator 131, an image depth assignment unit 132, a delayed synchronization signal generator 133, a pre-compensator 134, and a display control circuit 135.

The effective focal length calculator 131 may calculate effective focal lengths for respective ones of the plurality of lines included in the display panel 111. The effective focal length calculator 131 may calculate line-by-line effective focal lengths for each frame. The effective focal length calculator 131 may calculate the line-by-line effective focal lengths for each frame based on Equation 1 described with reference to FIGS. 6A and 6B or Equation 2 described with reference to FIGS. 7A and 7B.

The image depth assignment unit 132 may assign (or determine) image depths to respective ones of the lines of the display panel 111 based on the line-by-line effective focal lengths calculated by the effective focal length calculator 131. The image depth assignment unit 132 may assign image depths for each frame. In this case, even within the same frame, different image depths may be allocated to respective lines. The image depth assignment unit 132 may assign image depths to the plurality of lines based on the methods described with reference to FIGS. 6B, 7B, and 10B.

The delayed synchronization signal generator 133 may generate a delayed synchronization signal. The delayed synchronization signal is a control signal for generating a display synchronization signal such that the focus conversion device 112 is driven with a delay of a half-frame. The delayed synchronization signal may be included in a control signal CS and transmitted to the driving circuit 120. The driving circuit 120 may generate a display synchronization signal DSS that drives the focus conversion device 112 with a delay of a half-frame based on the delayed synchronization signal included in the control signal CS.

The pre-compensator 134 may pre-compensate image data in order to mitigate defocus blur occurring in the multifocal near-eye display system 100. By pre-compensating an input image, the pre-compensator 134 may facilitate the display of a sharp image. The pre-compensator 134 may pre-compensate the input image by assuming that a plurality of adjacent lines have the same defocus blur.

The display control circuit 135 may control operation of the driving circuit 120. The display control circuit 135 may generate image data DATA and control signals CS that are input to the driving circuit 120. The image data DATA may include pixel data for representing image depths. The control signals CS may include signals for controlling operation of the driving circuit 120. The image data DATA and the control signals CS may be output as image data DATA and control signals CS that are processed according to operations of the effective focal length calculator 131, the image depth assignment unit 132, the delayed synchronization signal generator 133, and the pre-compensator 134.

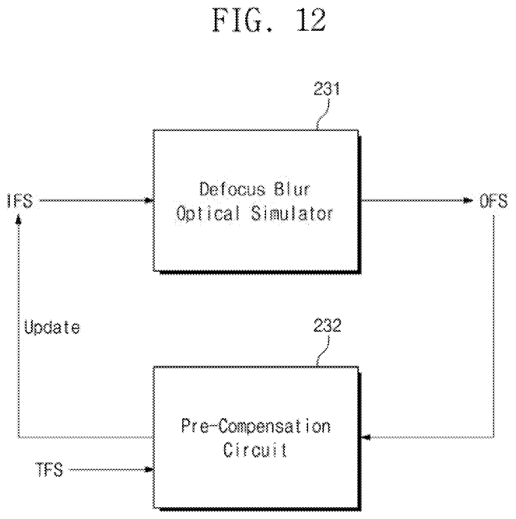

FIG. 12 is a block diagram illustrating a pre-compensator according to an embodiment of the present disclosure.

The pre-compensator 134 may include a defocus blur optical simulator 231 and a pre-compensation circuit 232.

In the present disclosure, the defocus blur optical simulator 231 may implement a defocus blur optical model for predicting blur characteristics of an image output through the display panel 111 and the focus conversion device 112. In some embodiments, the defocus blur optical model may be represented by a point spread function (PSF) or an effective point spread function (EPSF) corresponding to each line or a group of adjacent lines. That is, the defocus blur optical simulator 231 may generate the output frame set OFS by applying the PSF or EPSF defined by the defocus blur optical model to the input frame set IFS.

The defocus blur optical simulator 231 may simulate defocus blur for respective ones of lines of the display panel 111. For example, an input frame set IFS may be input to the defocus blur optical simulator 231. The defocus blur optical simulator 231 may generate a blurred output frame set OFS by applying a preset point spread function to the input frame set IFS. That is, the output frame set OFS may be a result of simulating an image rendered through the display panel 111 and the focus conversion device 112 based on the input frame set IFS. The defocus blur optical simulator 231 may assume that a plurality of adjacent lines have the same defocus blur. The defocus blur optical simulator 231 may be implemented based on calculated effective point spread functions.

The pre-compensation circuit 232 may calculate a loss between the output frame set OFS and a target frame set TFS. The pre-compensation circuit 232 may update the input frame set IFS based on the calculated loss. For example, the pre-compensation circuit 232 may update the input frame set IFS in a direction that minimizes the calculated loss. In this case, the pre-compensation circuit 232 may employ a gradient-based optimization algorithm, such as stochastic gradient descent (SGD) or an adaptive moment estimation (Adam) optimizer.

Due to variations in effective point spread functions (EPSFs) at the display panel 111, the ability to accurately represent an exact focus at an intended depth may be limited. The pre-compensator 134 may update the input frame set IFS in a direction that minimizes loss, thereby improving performance of the multifocal near-eye display system 100 such that an accurate focus may be achieved at a desired depth.

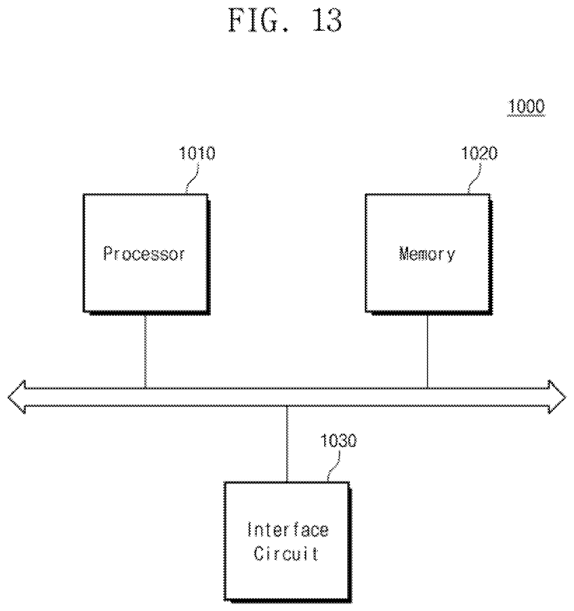

FIG. 13 is a diagram illustrating an example of a computing system constituting a controller according to an embodiment of the present disclosure.

Referring to FIG. 13, a computing system 1000 may include a processor 1010, a memory 1020, and an interface circuit 1030.

The processor 1010 may control overall operations of the controller 130, including data processing. The processor 1010 may execute firmware or software loaded in the memory 1020. The processor 1010 may include at least one general-purpose processor, such as a central processing unit (CPU) or an application processor (AP). The processor 1010 may also include at least one special-purpose processor, such as a neural processing unit (NPU), a neuromorphic processor, or a graphics processing unit (GPU). The processor 1010 may include two or more processors of the same type.

The memory 1020 may store code and instructions executed by the processor 1010. The memory 1020 may store data processed by the processor 1010. For example, the memory 1020 may store various data and information including pixel data for respective ones of a plurality of image depths and frame sets used for pre-compensation. The memory 1020 may include a volatile memory, such as random access memory (RAM) or static random access memory (SRAM), or a non-volatile memory including at least one of a flash memory, a hard disk, a multimedia card micro type memory, a card-type memory (for example, an SD or XD memory), read-only memory (ROM), electrically erasable programmable read-only memory (EEPROM), or programmable read-only memory (PROM).

The interface circuit 1030 may provide signal or data communication between the computing system 1000 and an external entity. For example, the processor 1010 may receive data to be displayed from an external entity (for example, a host) through the interface circuit 1030. The processor 1010 may generate image data DATA and control signals CS for a display operation, and the interface circuit 1030 may transmit the image data DATA and the control signals CS to the driving circuit 120.

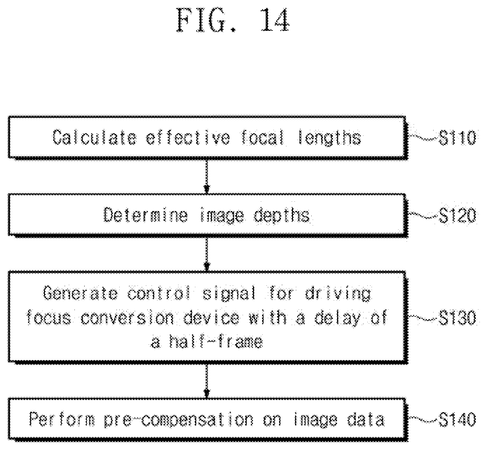

FIG. 14 is a flowchart illustrating an operating method of a multifocal near-eye display system according to an embodiment of the present disclosure.

Referring to FIG. 14, the operating method of the multifocal near-eye display system 100 may include calculating effective focal lengths corresponding to respective ones of a plurality of lines of a display panel (S110). The step S110 may be performed by the effective focal length calculator 131 of the controller 130.

The operating method of the multifocal near-eye display system 100 may include determining image depths for respective ones of the plurality of lines based on the effective focal lengths (S120). The step S120 may be performed by the image depth assignment unit 132 of the controller 130.

The operating method of the multifocal near-eye display system 100 may include generating a control signal for driving a focus conversion device with a half-frame delay relative to the display panel (S130). The step S130 may be performed by the delayed synchronization signal generator 133 of the controller 130.

The operating method of the multifocal near-eye display system 100 may include performing pre-compensation on image data (S140). The step S140 may be performed by the pre-compensator 134 of the controller 130.

According to an embodiment of the present disclosure, the multifocal near-eye display system may mitigate depth separation and depth diffusion phenomena caused by rolling updates of a display panel in a display device driven in an active-matrix manner. According to an embodiment of the present disclosure, the multifocal near-eye display system may enable a sharp image to be displayed at a central region of a user's field of view. According to an embodiment of the present disclosure, the multifocal near-eye display system may reduce residual defocus blur by pre-compensating an input image according to effective point spread functions.

The above-described matters are specific embodiments for implementing the present disclosure. The present disclosure is not limited to the above-described embodiments, and may include embodiments that are simply modified in design or easily changed. In addition, the present disclosure may include technologies that can be easily modified and implemented using the embodiments. Accordingly, the scope of the present disclosure should not be construed as being limited to the above-described embodiments, but should be determined by the appended claims and equivalents of the claims.

What is claimed is:

1. A multifocal near-eye display system comprising:
a display panel including a plurality of lines;
a focus conversion device configured to adjust a focal length in response to a display synchronization signal;
a driving circuit configured to generate a display driving signal for sequentially driving the plurality of lines and the display synchronization signal for controlling operation of the focus conversion device according to an image frame; and
a controller configured to control operation of the driving circuit, calculate effective focal lengths corresponding to respective ones of the plurality of lines, and determine image depths to be displayed on respective ones of the plurality of lines based on the calculated effective focal lengths.

2. The system of claim 1, wherein the effective focal length is determined based on the following equation,
$${f}_{L , N} = {W}_{N}^{1 st} \times {f}_{1 st} + {W}_{N}^{2 nd} \times {f}_{2 nd} ,$$
wherein f_{L,N} denotes an effective focal length of an N-th line among the plurality of lines,
wherein f₁ₛₜ denotes a focal length of the focus conversion device at a time when pixel data of the N-th line is updated,
wherein f_{2nd} denotes a focal length of the focus conversion device immediately before the pixel data of the N-th line is updated in a next frame,
wherein
$${W}_{N}^{1 st}$$
denotes a time weight applied when the focal length of the focus conversion device is f₁ₛₜ at the N-th line, and
wherein
$${W}_{N}^{2 nd}$$
denotes a time weight applied when the focal length of the focus conversion device is f_{2nd} for the N-th line.

3. The system of claim 1, wherein the effective focal length is determined based on the following equation,
$${f}_{L , N}^{( M )} = \frac{1}{F} {\int }_{{t}_{N}^{( M )}}^{{t}_{N}^{( M + 1 )}} f ( t ) dt ,$$
wherein
$${f}_{L , N}^{( M )}$$
denotes an effective focal length of an N-th line in an M-th frame,
wherein
$${t}_{N}^{( M )}$$
denotes an update time of the N-th line in the M-th frame,
wherein
$${t}_{N}^{( M + 1 )}$$
denotes an update time of the N-th line in an (M+1)-th frame,
wherein f(t) denotes a focal length of the focus conversion device as a function of time, and
wherein F denotes a duration time of one frame.

4. The system of claim 1, wherein the driving circuit is configured to drive the focus conversion device with a delay of a half-frame relative to a driving timing of the display panel.

5. The system of claim 1, wherein the controller is configured to perform pre-compensation on image data corresponding to the plurality of lines.

6. The system of claim 5, wherein the controller is configured to generate an output frame set by applying a defocus blur optical model to an input frame set, and update the input frame set based on a loss between a target frame set and the output frame set.

7. The system of claim 6, wherein the controller is configured to perform the pre-compensation based on stochastic gradient descent (SGD) or an adaptive moment estimation (Adam) optimizer.

8. The system of claim 1, wherein the display panel is configured to be driven in an active-matrix manner.

9. The system of claim 1, wherein the display panel is configured to be driven in a rolling update manner.

10. A controller for a multifocal near-eye display system, comprising:
a display control circuit configured to control an operation of a driving circuit;
an effective focal length calculator configured to calculate effective focal lengths corresponding to respective ones of a plurality of lines of a display panel; and
an image depth assignment unit configured to determine image depths to be displayed on respective ones of the plurality of lines based on the calculated effective focal lengths.

11. The controller of claim 10, wherein the effective focal length calculator is configured to calculate the effective focal length based on the following equation,
$${f}_{L , N} = {W}_{N}^{1 st} \times {f}_{1 st} + {W}_{N}^{2 nd} \times {f}_{2 nd} ,$$
wherein f_{L,N} denotes an effective focal length of an N-th line among the plurality of lines,
wherein f₁ₛₜ denotes a focal length of the focus conversion device of the multifocal near-eye display system when pixel data of the N-th line is updated,
wherein f_{2nd} denotes a focal length of the focus conversion device immediately before the pixel data of the N-th line is updated in a next frame,
wherein
$${W}_{N}^{1 st}$$
denotes a time weight applied when the focal length of the focus conversion device is f₁ₛₜ for the N-th line, and
wherein
$${W}_{N}^{2 nd}$$
denotes a time weight applied when the focal length of the focus conversion device is f_{2nd} for the N-th line.

12. The controller of claim 10, wherein the effective focal length calculator is configured to calculate the effective focal length based on the following equation,
$${f}_{L , N}^{( M )} = \frac{1}{F} {\int }_{{t}_{N}^{( M )}}^{{t}_{N}^{( M + 1 )}} f ( t ) dt ,$$
wherein
$${f}_{L , N}^{( M )}$$
denotes an effective focal length of an N-th line in an M-th frame,
wherein
$${t}_{N}^{( M )}$$
denotes an update time of the N-th line in the M-th frame,
wherein
$${t}_{N}^{( M + 1 )}$$
denotes an update time of the N-th line in an (M+1)-th frame, and
wherein f(t) denotes a focal length of the focus conversion device as a function of time, and
wherein F denotes a duration time of one frame.

13. The controller of claim 10, further comprising a delayed synchronization signal generator configured to generate a control signal for driving a focus conversion device of the multifocal near-eye display system with a delay of a half-frame relative to the display panel.

14. The controller of claim 10, further comprising a pre-compensator configured to perform pre-compensation on image data corresponding to the plurality of lines.

15. The controller of claim 14, wherein the pre-compensator comprises:
a defocus blur optical simulator configured to apply a preset defocus blur model to an input frame set; and
a pre-compensation circuit configured to update the input frame set based on a loss between an output frame set of the defocus blur optical simulator and a target frame set.

16. The controller of claim 15, wherein the pre-compensation circuit performs the pre-compensation based on stochastic gradient descent (SGD) or an adaptive moment estimation (Adam) optimizer.

17. The controller of claim 10, wherein the display panel is configured to be driven in an active-matrix manner.

18. The controller of claim 10, wherein the display panel is configured to be driven in a rolling update manner.

19. A method of operating a multifocal near-eye display system, comprising:
calculating effective focal lengths corresponding to respective ones of a plurality of lines of a display panel;
determining image depths to be displayed on respective ones of the plurality of lines based on the calculated effective focal lengths;
generating a control signal for driving a focus conversion device with a delay of a half-frame relative to a driving timing of the display panel; and
performing pre-compensation on image data corresponding to the plurality of lines.

20. The method of claim 19, wherein the performing pre-compensation comprises:
applying a preset defocus blur model to an input frame set to generate an output frame set; and
updating the input frame set based on a loss between the output frame set and a target frame set.
